(19) United States
(12) Patent Application Publication
(10) Pub. No.: US 2025/0011038 A1
(43) Pub. Date: Jan. 9, 2025

(54) UTILITY MODULE AND CONNECTIVITY SYSTEM THEREFOR

(71) Applicant: KETER HOME AND GARDEN PRODUCTS LTD, Herzliya (IL)

(72) Inventors: Dikla MUALEM, Shoham (IL); Richard EVANS, Longmeadow, MA (US)

(73) Assignee: KETER HOME AND GARDEN PRODUCTS LTD, Herzliya (IL)

(21) Appl. No.: 18/712,237

(22) PCT Filed: Nov. 8, 2022
(86) PCT No.: PCT/IL2022/051179

§ 371 Date: May 21, 2024

(30) Foreign Application Priority Data
Nov. 23, 2021 (IL) 288315

(51) Int. Cl. B65D 21/02

(52) U.S. Cl. CPC B65D 21/0228

(57) ABSTRACT

A utility assembly includes at least one first utility module and at least one second utility module and a coupling mechanism for detachable articulation a second utility module to a first utility module. The coupling mechanism includes a male coupling portion associated with one utility modules, and a female coupling portion associated with another one utility modules. The male coupling portion has at least a pair of symmetrically distributed locking members laterally projecting from a male rotation axis normal to a projecting locking plane, and the female coupling portion is configured with corresponding at least a pair of symmetrically distributed locking recesses extending from a female rotation axis normal to a depressed receiving plane. The locking members are disposed in register with the locking recesses and said female rotation axis coinciding with said male rotation axis, and the locking members are configured for rotation engagement by said locking recesses.

### TECHNOLOGICAL FIELD

The presently disclosed subject matter is directed to a utility assembly and a connectivity system configured to facilitate detachable attaching of utility modules to one another.

The term ‘utility module’ is used hereinafter in its broad meaning and is meant to denote a variety of articles such as, storage containers, travel luggage, tool boxes, organizers, compacted work benches, cable storage, tools (e.g. hand tools, power generators and power sources), communication modules, carrying platforms, racks, locomotion platforms, electric and electronic appliances, cups, etc., of any shape and size, and wherein any utility module can be detachably attached to other one or more utility modules.

### BACKGROUND ART

References considered to be relevant as background to the presently disclosed subject matter are listed below:
U.S. Pat. No. 11,059,631
U.S. Pat. No. 10,603,783
US20210221561

Acknowledgement of the above references herein is not to be inferred as meaning that these are in any way relevant to the patentability of the presently disclosed subject matter.

### BACKGROUND

U.S. Pat. No. 11,059,631 discloses a connectivity system for a utility module, including one or both of: a rigid base portion with at least one engaging tab projecting at a first edge portion of the rigid base portion, and at least one locking receptacle disposed at a second edge portion of the rigid base portion; and a rigid mounting platform comprising an upwardly extending perimetric rim defining a utility module arresting space, the rim being configured with at least one tab arresting receptacle at a first location, and at least one locking latch at a second location.

U.S. Pat. No. 10,603,783 is directed to a tool container system includes a first tool container and a second tool container. The first tool container has a first base, a first cover pivotably attached to the first base by a first hinge portion, a first base locking member coupled to the base, a first cover locking member coupled to the first cover, and a first latch coupled to the first base and moveable between a first unlocked position in which the first cover is movable relative to the first base between a closed position and an open position, and a first locked position in which the first latch engages the first cover locking member and the first cover is locked to the first base in the closed position. The second tool container is stackable on the first cover of the first tool container and having a second locking member. When the second tool container is stacked on the first tool container, the second tool container is lockable to the first tool container when the first latch is moved to the first locked position to engage both the first cover locking member and the second locking member.

US20210221561 is concerned with a stackable storage system includes a first container, a second container, and a latch moveable between a first position and a second position. The first container includes a projection extending away from the first container along a stacking direction. An edge portion extends from the projection along a plane substantially perpendicular to the stacking direction. The second container includes a recess. The recess receives the projection when the first container and the second container are stacked relative to one another in the stacking direction. The latch overlaps the edge portion with respect to the stacking direction while in the first position to secure the first container and the second container. The latch and edge portion are positioned in a non-overlapping manner relative to one another while the latch is in the second position to permit separation of the first container from the second container.

### GENERAL DESCRIPTION

The present disclosure is concerned with a utility module connectivity system, facilitating fast and easy attaching/detaching of utility modules to/from one another, whilst offering rigid and firm connectivity.

According to a first aspect of the disclosure there is disclosed a utility assembly comprising at least one first utility module and at least one second utility module; a coupling mechanism for detachable articulation a second utility module to a first utility module, said coupling mechanism comprising a male coupling portion associated with one of the at least one first utility module and the at least one second utility module, and a female coupling portion associated with another one of the at least one first utility module and the at least one second utility module; wherein the male coupling portion is configured with at least a pair of symmetrically distributed locking members laterally projecting from a male rotation axis normal to a projecting locking plane, and the female coupling portion is configured with at least a pair of corresponding symmetrically distributed locking recesses extending from a female rotation axis normal to a depressed receiving plane, said locking members disposed in register with said locking recesses and said female rotation axis coinciding with said male rotation axis, and wherein said locking members are configured for rotation engagement by said locking recesses.

According to a specific arrangement of the utility assembly each one of the first utility module and the second utility module comprises a male coupling portion and a female coupling portion, wherein the male rotation axis and the female rotation axis of each of the first utility module and the second utility module coincide, and wherein the male coupling portion and the female coupling portion are coaxially disposed at different radii.

According to this arrangement, the locking members are disposed at 90° with respect to the locking recesses of a respective utility module.

According to a particular configuration, at an assembled, interlocked position, the second utility module is disposed over the first utility module such that side walls of both utility modules face at same orientation.

The arrangement is such that a second utility module comprising only one of the male coupling portion and the female coupling portion, can be articulated over the first utility module using one of the other one of the male coupling portion and the female coupling portion, and a second utility module comprising both of the male coupling portion and the female coupling portion can be articulated over the first utility module using both of the male coupling portion and the female coupling portion.

The laterally projecting locking members of the male coupling portion and the locking recesses of the female coupling portion can be disposed parallel with regular edges of the first utility module and the second utility module, respectively.

A tangent of the laterally projecting locking members of the male coupling portion and of the locking recesses of the female coupling portion can be disposed symmetrically with respect to said first utility module and the second utility module, respectively.

The laterally projecting locking members of the male coupling portion and the locking recesses of the female coupling portion can be disposed parallel with respect to a surface of the first utility module and the second utility module, respectively.

According to one arrangement, locking engagement can take place in two directions, and according to another arrangement locking engagement can take place in one direction only, wherein one or both of at least one of the locking members and of the at least one of the locking recesses is configured with a stopper, whereby engaging is unidirectional, such that the second utility module can be rotated into engagement with the first utility module in one direction only. According to a second aspect of the disclosure there is disclosed a utility module comprising one or both of an attaching face and a bearing face wherein one or both of said attaching face and the bearing face comprises a coupling mechanism for detachable articulation with another utility module, said coupling mechanism comprising a male coupling portion and a female coupling portion; wherein the male coupling portion is configured with at least a pair of symmetrically distributed locking members laterally projecting from a male rotation axis parallel with a plane of the base member and the lid, respectively, and the female coupling portion is configured with at least a pair of corresponding symmetrically distributed locking recesses extending from a female rotation axis parallel with a plane of the base member and the lid, respectively, said locking members disposed in register with said locking recesses and said female rotation axis coinciding with said male rotation axis, and wherein locking members are configured for rotation engagement by locking recesses of the second utility module.

According to another aspect of the disclosure there is a container comprising side walls extending from a base member and a closable lid, defining together a confined storage space; wherein one or both of said base member and said lid comprises a coupling mechanism for detachable articulation with a utility module, said coupling mechanism comprising a male coupling portion and a female coupling portion; wherein the male coupling portion is configured with at least a pair of symmetrically distributed locking members laterally projecting from a male rotation axis parallel with a plane of the base member and the lid, respectively, and the female coupling portion is configured with at least a pair of corresponding symmetrically distributed locking recesses extending from a female rotation axis parallel with a plane of the base member and the lid, respectively, said locking members disposed in register with said locking recesses and said female rotation axis coinciding with said male rotation axis, and wherein locking members are configured for rotation engagement by locking recesses of a utility module.

According to an aspect of the disclosure there is disclosed a utility assembly comprising at least one first utility module and at least one second utility module; a coupling mechanism for detachable articulation a second utility module to a first utility module, said coupling mechanism comprising a male bayonet coupling portion and a female bayonet coupling portion coaxial disposed radially inwards of said male bayonet coupling portion, on a face of one of the first utility module and the second utility module; and a female bayonet coupling portion and a male bayonet coupling portion coaxial disposed radially inwards of said male bayonet coupling portion, on a face of the other one of the first utility module and the second utility module and configured for interlocking articulation with the male bayonet coupling portion and a female bayonet coupling portion of the first utility module.

Any one or more of the following features, designs and configuration can be applied to any one or more of the aspects and embodiments of the present disclosure, separately or in various combinations thereof:
A footprint of the second utility module can be smaller or greater than a footprint of the first utility module, whereby only a center, inner most couple of a male-female coupling is configured for rotation engagement with one another;
One or both of a first utility module and a second utility module can be a container;
The container can be configured for water-tight sealing, by a sealing gasket disposed at least at a lid of the container;
The container can be scent proof and dust proof;
At the first utility module, a topmost surface of the male coupling portion can be coplanar with a topmost portion of the female coupling portion;
At the second utility, module a bottommost surface of the male coupling portion can be coplanar with a bottommost portion of the female coupling portion;
The first utility module can be an interlocking base unit configured for articulating thereto a second utility module;
The interlocking base unit can be integral with or mounted on a carrying member;
The carrying member can be a truck bed, a hand truck, a worktable, a mounting wall, etc.;
A surface of the locking members of the male coupling portion and a corresponding facing surface of the locking recesses of the female coupling portion can be configured with a rotation preventing mechanism;
The rotation preventing mechanism comprises mating ridges and depressions disposed over facing surfaces of the locking recesses of the female coupling portion, said rotation preventing mechanism configured for engagement when the first utility module and the second utility module are interlocked and upon applying axial displacement of the second utility module with respect the first utility module; such axial displacement can occur upon lifting an assembled utility assembly by the second utility module;
The rotation preventing mechanism is configured to eliminate or substantially reduce the likelihood of unintentional rotational disengagement of the second utility module from the first utility module;
A top surface of the first container can be configured with depressed gliding surfaces, having chamfered edges, for positioning the male coupling portion of the second utility module in a prior-to-locking position with respect to the female coupling portion of the first utility module;
When a second container is articulated over a first container there exists a small degree of freedom about a coaxial axis of the two containers;
The container can be configured with a double locking mechanism for securely locking the lid over the container at a closed position;
A first locking mechanism of the container comprises at least a pair of side latches, each disposed at opposite sides of the container and where each latch is pivotally articulated at one of the lid and side wall of the container and configured for lock-engagement with a lock arrest configured at the other one of the lid and side wall of the container;
The side latches can be toggle-type latches;
A second locking mechanism of the container comprises one or more of swing handles, each comprising a handle portion pivotally articulated at a side wall portion of the lid and comprising at respective ends thereof an arced arm projectable through a top surface of the lid and configurable between a locked position at which the handle is displaced against the lid and wherein each arced arm engages with an arresting aperture at a top portion of a side wall of the container, and an unlocked position wherein the handle is displaced from the top surface of the lid and wherein the arced arms disengage from the respective arresting aperture;
At the unlocked position the swing handles can be pivotally disposed at least at 90°, whereby the lid can be removed from the container and serve as a tray, resting upside down over the swing handles;
The swing handles can be symmetrically and evenly arrested at the open position;
The swing handles can be arrested at the locked position by the side latches of the first locking mechanism;
The arced arm can be eccentric and configured for increasing arresting engagement with the arresting aperture as it is pivotally displaced into its closed position, thus increasing sealing force of the lid over the container;
At least a portion of the arced arm can be serrated, at least over one plane, for clicking engagement with the arresting aperture, at a ratchet-like manner;
The lid can be configured at an inside face thereof with an organizer;
The organizer can be detachably attachable to a bottom face of the lid;
The container can be configured with a braided paracord, detachably articulated to a portion of the container;
The braided paracord can be detachably applied to the swing handle, proving soft grip while attached to the swing handle;
The paracord can be attached to the swing handle by two buckles attachable to one another;
The container can be configured with two or more secure-down (tie-down) arrangements, disposed at opposite sides of the container, for securing the container to a carrying platform;
The container can be configured with a lock arrangement to prevent unauthorized opening of the container;
The male and/or female coupling arrangements can be configured with a rounded edge;
A utility module according to the disclosure can be configured with any one or both of the two male/female coupling arrangements, and that each of the coupling arrangements can be disposed as either a central or a peripheral coupling arrangement, and further, the coupling arrangements can be disposed at a different orientation about the axes of the utility module;
The swing handle can be used for manipulating/handling the lid;
The locking assembly is configured for arresting the lid over the container, and a container carrying portion is configured below the locking assembly;
The second utility module can be rotatably displaceable in a rotation plane parallel to the locking plane of the coupling mechanism of the first utility module, with an axis of rotation (Z) extending normal through said plane;
A top face surface of the locking ribs can extend parallel to the locking plane;
A top face surface of the locking recesses can extend parallel to the locking plane;
A top face of the locking members and/or of the locking recesses can be configured with a locking recess arresting enhancing arrangement. The locking recess arresting enhancing arrangement can be a friction enhancing surface configured with projections;
The locking recess arresting enhancing arrangement can be applied through imparting one or both of the locking members and/or the locking recesses a mild inclination, i.e, wherein said locking members and/or the locking recesses are disposed at a mild angle with respect to axis of rotation (Z) extending normal through said plane.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a top perspective view of a utility module, namely a container, according to an example of the disclosure;

FIG. 1B is a bottom perspective view of the container shown in FIG. 1A;

FIG. 2A is a section taken along line 2A-2A in FIG. 1A;

FIGS. 3A and 3B are a planar view of FIGS. 2A and 2B, respectively;

FIG. 4 is an enlargement of the portion marked 4 in FIG. 1A;

FIG. 5A is an enlargement of the portion marked 5 in FIG. 1B;

FIG. 5B is the same as FIG. 5A, illustrating an arresting enhancing arrangement;

FIGS. 6A to 6D are consecutive steps illustrating the assembly of a utility module assembly, according to an example of the disclosure;

FIG. 7A is a section along line 7A-7A in FIG. 6B, illustrating a second utility module positioned over a first utility module, however not at a locked position;

FIG. 7B is a section along line 7B-7B in FIG. 6B;

FIG. 8A is a section along line 8A-8A in FIG. 6D;

FIG. 8C is an enlargement of the portion marked 8C in FIG. 8B;

FIG. 8D is an enlargement of the portion marked 8D in FIG. 8A;

FIG. 8E is an enlargement of the portion marked 8E in FIG. 7B;

FIG. 8F is an enlargement of the portion marked 8F in FIG. 7A;

FIGS. 9A and 9B are sectioned views, taken in direction of arrow IX in FIG. 8A, showing only elements of the male-female coupling mechanism at a coupled position, at a rest position and upon lifting the second utility module, respectively;

FIGS. 10A and 10B are local sections along line X-X in FIG. 8A, corresponding with FIGS. 9A and 9B, respectively;

FIG. 11 is a top perspective view of a container according to an example of the disclosure, illustrating a handle and locking assembly at a fully open position;

FIG. 12A is a perspective view of the handle only;

FIG. 12B is an enlarged view of the portion marked 12B in FIG. 12A;

FIG. 12C illustrated a paracord/padding arrangement separated from the handle illustrated in FIG. 12A;

FIG. 12D illustrates paracord attaching/detaching to the handle of FIG. 12A;

FIG. 13 is an enlarged perspective view of the handle base, at an open position;

FIGS. 14A to 14D are consecutive steps of locking/unlocking a container's lid to a container, according to an example of the present disclosure;

FIG. 15 is a local section taken along line 15-15 in FIG. 14C;

FIG. 16A illustrates a lid of the container, according to an example of the disclosure, configured into a table resting over deployed locking arms, the lid configured with a lid organizer;

FIG. 16B is the same as FIG. 16A, with the arms at a folded/locked position;

FIG. 16C is the same as FIG. 16A, with a lid organizer at an open position;

FIG. 17A illustrates a container, according to an example of the disclosure, configured with wheels;

FIG. 17B illustrates a container, according to an example of the disclosure, configured with flexible carrying handles;

FIG. 17C illustrates a utility assembly, according to an example of the disclosure, wherein a first utility module has a greater footprint than a second utility module articulated thereto; and

FIG. 17D illustrates a utility assembly, according to an example of the disclosure, comprising several utility module tiers.

### DETAILED DESCRIPTION OF EMBODIMENTS

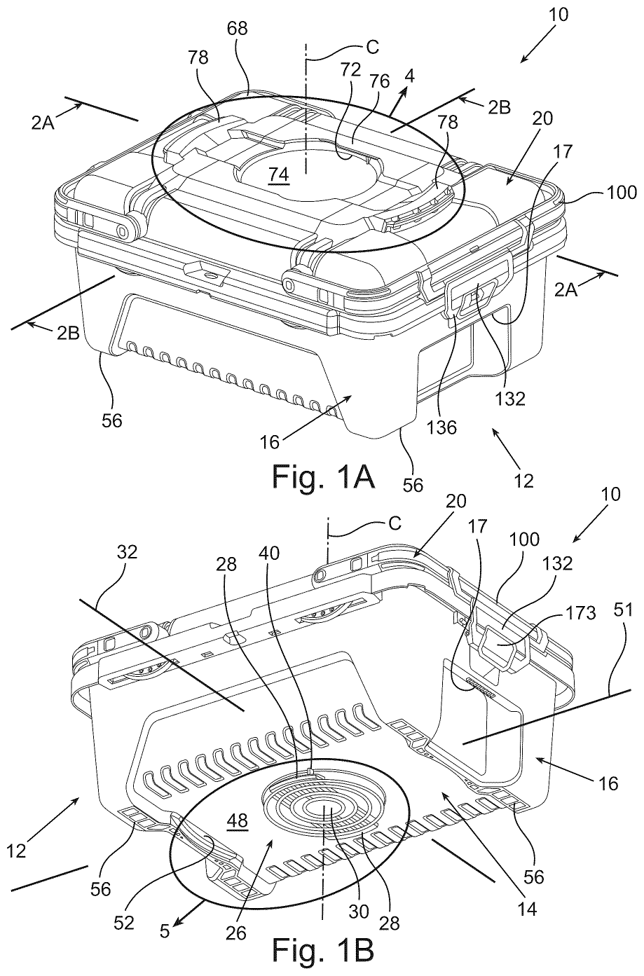

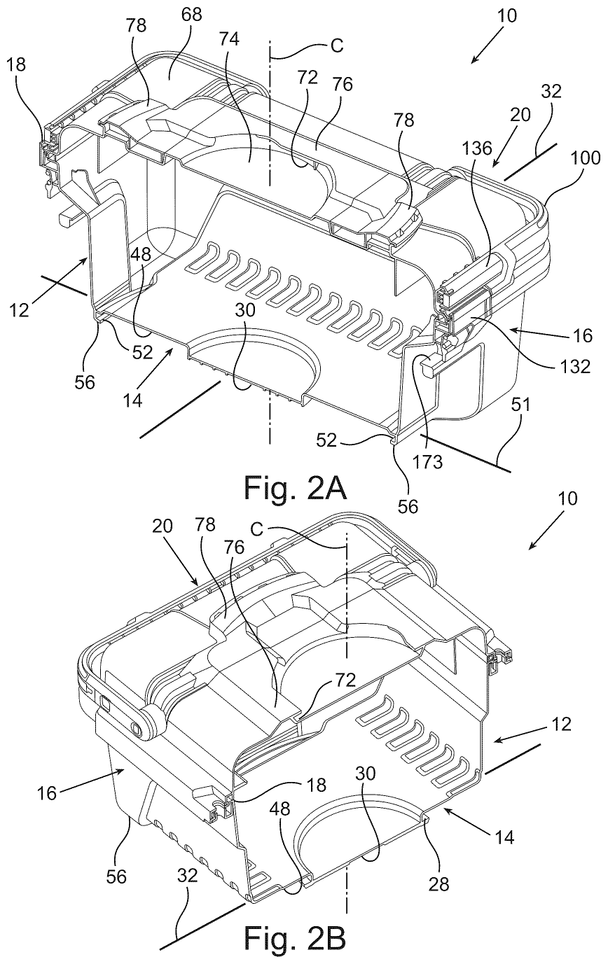

Attention is first directed to FIGS. 1 to 5 of the drawings, exemplifying a utility module according to the present disclosure, generally designated 10. Whilst throughout the specification a ‘utility module’ is referred to and exemplified as a container, it is appreciated that this term is used at its broad meaning and is meant to denote a variety of articles such as, storage containers, travel luggage, tool boxes, organizers, compacted work benches, cable storage, tools (e.g. hand tools, power generators and power sources), communication modules, carrying platforms, racks, locomotion platforms, electric and electronic appliances, cups, etc., of any shape and size, and wherein any utility module can be detachably attached to other one or more utility modules. Thus, hereinafter the term utility module is interchangeably used with the term container. The container 10 comprises a base portion 12 comprising a base 14 with side walls 16 (namely a right-side wall, a left-side wall, a front-side wall, and a back-side wall) extending therefrom towards a top edge 18 of the container. Noticeably, the base 14 can be integral with or integrated with the utility module. A lid 20 is detachably secured over the container 10, as will be discussed hereinafter in greater detail.

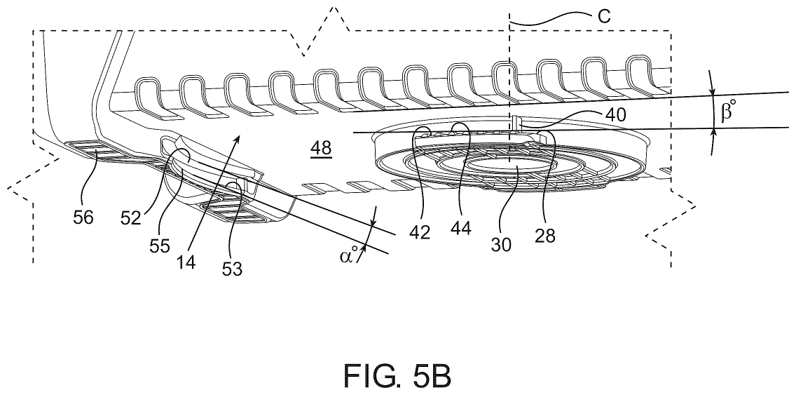

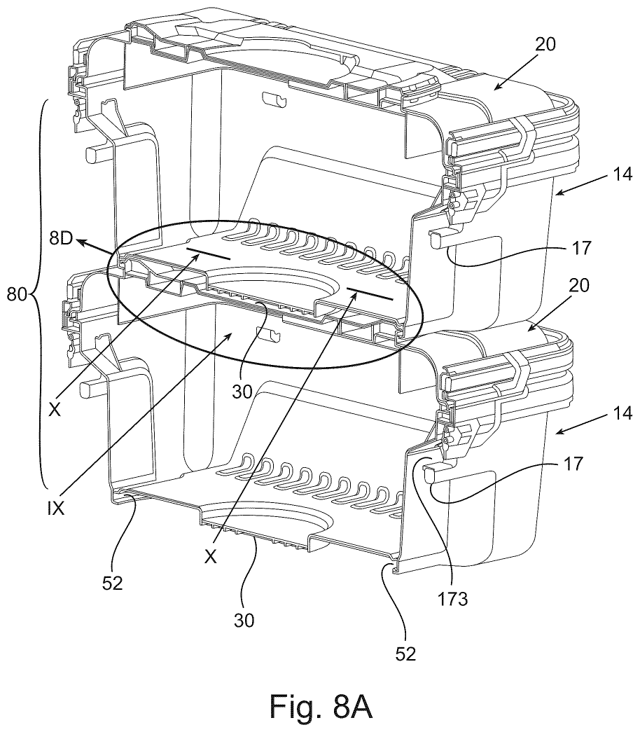

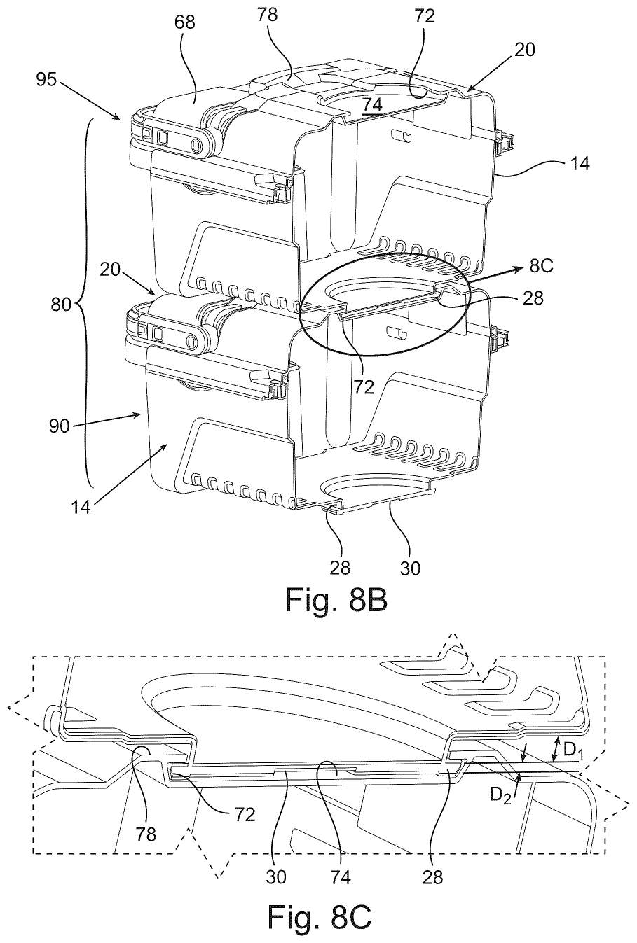

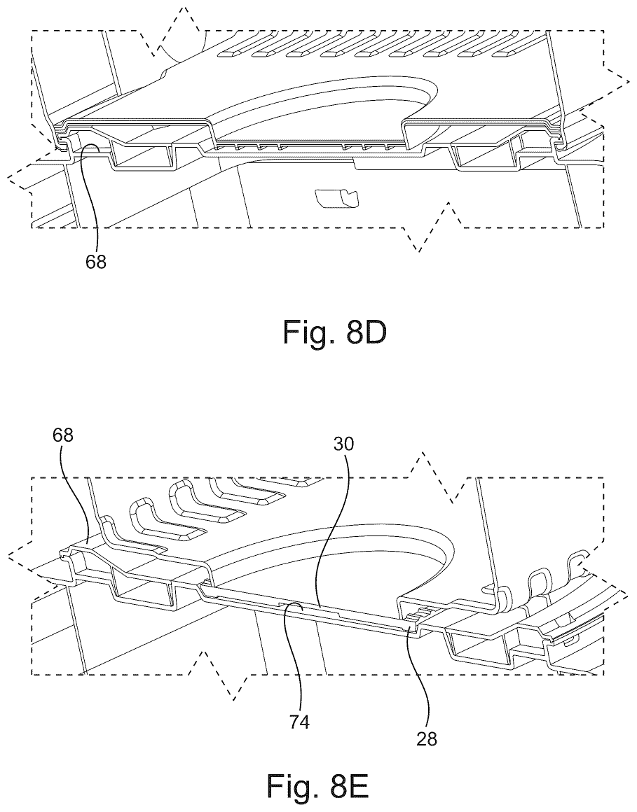

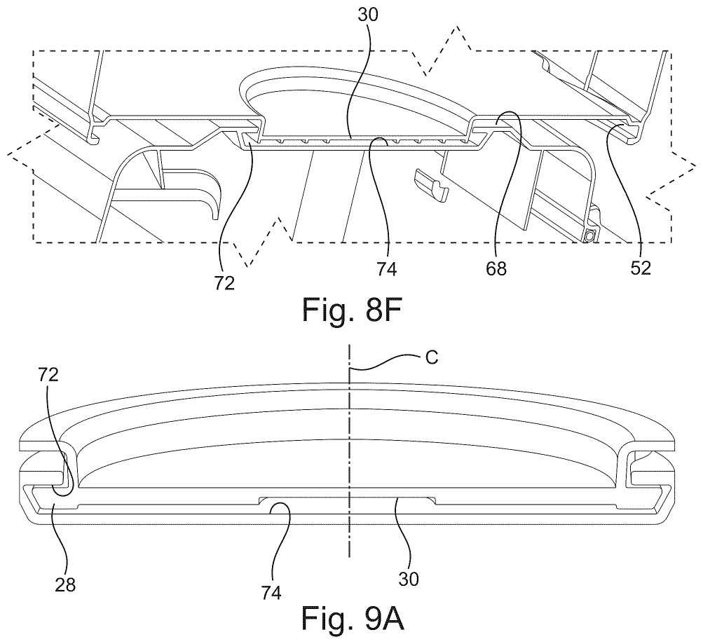

Base 14 is configured with a coupling mechanism comprising a male coupling portion and a female coupling portion, wherein a central male coupling portion 26 is configured with a pair of symmetrically distributed locking members 28 laterally projecting from a male projecting locking plane (hub) 30 about a central rotation axis C, normal to the projecting locking plane 30. The locking members 28 are wing-like shaped and are disposed such that they extend in a direction along a central back-front axis 32 of the container 10. Each of the locking members 28 is configured with a stopper member 40 (best seen in FIG. 5A) and has at a top surface thereof 42 a plurality of upwards facing ribs 44 disposed parallel with the back-front axis 32, the purpose of which will be discussed hereinafter. It can be seen (best in FIGS. 8C, 9A and 10B) that the top surface 42 is spaced apart at a distance D₁ from a bottom surface 48 of the base of the container 10 and having a thickness of D₂.

As seen in FIG. 5B, a top face 53 of the rib 55 (of recess 52) is inclined at a mild angle α° with respect to locking plane 30, and likewise, top surface of the locking members 28 is inclined at a mild angle β°, such that upon rotating the containers into locking engagement entails enhanced friction engagement between the respective locking recesses and locking members.

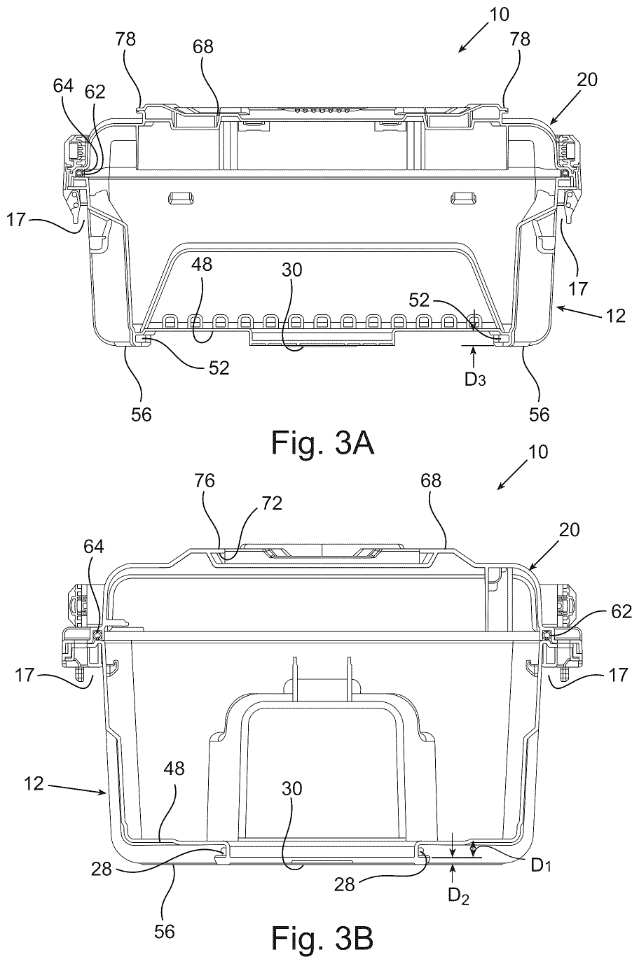

The female coupling portion of the coupling mechanism of the base 14 is configured with a pair of symmetrically distributed locking recesses 52, laterally extending from a female rotation axis coextending with the central rotation axis C and parallel with plane of the base member (namely surface 48 thereof), however extending along axis 51 traversing axis 32 at a right angle. The locking recesses 52 have a gap D₃ (FIG. 3A) similar to, or slightly greater than thickness D₂, thus configured for arresting therein a male locking members 28.

According to a particular configuration, the second utility module is rotatably displaceable in a rotation plane parallel to the locking plane of the coupling mechanism of the first utility module, with an axis of rotation extending normal through said plane. Nonetheless, it is appreciated that locking ribs and locking recesses can assume different modifications. For example, a top face surface of the locking ribs can extend parallel to the locking plane. Alternatively, a top face surface of the locking recesses can extend parallel to the locking plane.

Furthermore, a face of the locking members and/or of the locking recesses can be configured with a locking recess arresting enhancing arrangement. The locking recess arresting enhancing arrangement can be a friction enhancing surface configured with projections (e.g. ribs 44 and 77, respectively). Alternatively, the locking recess arresting enhancing arrangement can be applied through imparting one or both of the locking members and/or the locking recesses a mild inclination, i.e, wherein said locking members and/or the locking recesses are disposed at a mild angle with respect to axis of rotation (C) extending normal through said plane.

It is further noted that the recesses 52 are each received within base support portions 56 extending alongside edges of the base 14, projecting from bottom surface 48 and extending substantially coplanar with the projecting locking plane (hub) 30, together serving as a ground rest surface.

In the example discussed hereinabove, the base 14 is configured with a central male coupling portion 26 and a peripheral female coupling portion 28. It is however appreciated that a utility module according to the disclosure can be configured with any one or both of the two male/female coupling arrangements, and that each of the coupling arrangements can be disposed as either a central or a peripheral coupling arrangement, and further, the coupling arrangements can be disposed at a different orientation about the axes of the utility module.

Container 10 is further configured with a detachable lid 20, though it is appreciated that according to another example (not shown) the lid can be pivotally articulated to the body, namely base portion 12. The lid 20 is configured with a peripheral rim 62, fitted with a sealing gasket 64 (FIGS. 3A and 3B) rendering the container at its closed position to be liquid tight, gas tight, dust free and scent free.

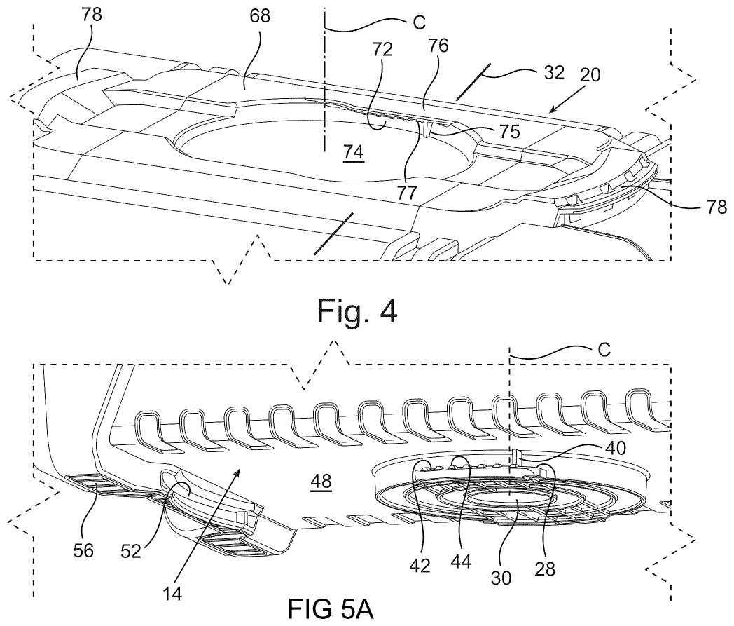

A top face 68 of the lid 20 is configured with a central female coupling portion comprising a pair of symmetrically distributed locking recesses 72 extending from a female rotation axis, coaxial with central axis C and normal to a depressed receiving plane 74, said plane shaped and sized to accommodate male projecting locking plane (hub) 30 of the base 14. The locking recesses 72 are disposed parallel over the central back-front axis 32 of the container 10 and the gap of the locking recesses 72 is shaped and sized for arresting the male locking members 28 of another utility module, at a bayonet style coupling, as will be explained hereinbelow. As can be seen, best in FIG. 4, the locking recesses 72 are configured with a stopper member 75 and a bottom surface of a flanging portion 76 (coplanar with surface 68 which together with surface 74 constitutes the locking recesses 72) is configured with a plurality of downward facing ribs 77 disposed parallel with the back-front axis 32, configured for mating with ribs 44 of the male locking members 28, the purpose of which will be discussed hereinafter.

Lid 20 is also configured with a male coupling arrangement, by way of a pair of symmetrically distributed locking members 78 laterally extending outwards from top face 68 of the lid 20, parallel distributed about axis 51 and coaxial with central longitudinal axis C.

Noticeably, the male locking members 78 are shaped and spaced apart from one another in corresponding with the locking recesses 52 of the coupling mechanism of the base 14 and likewise, the central female locking recesses 72 of the lid 20 are shaped and spaced apart in correspondence with male locking members 28 of the base 14. Accordingly, the male locking members 28 of a first utility module can be arrested by central female locking recesses 72 of a second utility module, and locking recesses 52 of the first utility module can arrest male locking members 78 of the second utility module, as will be exemplified hereinafter.

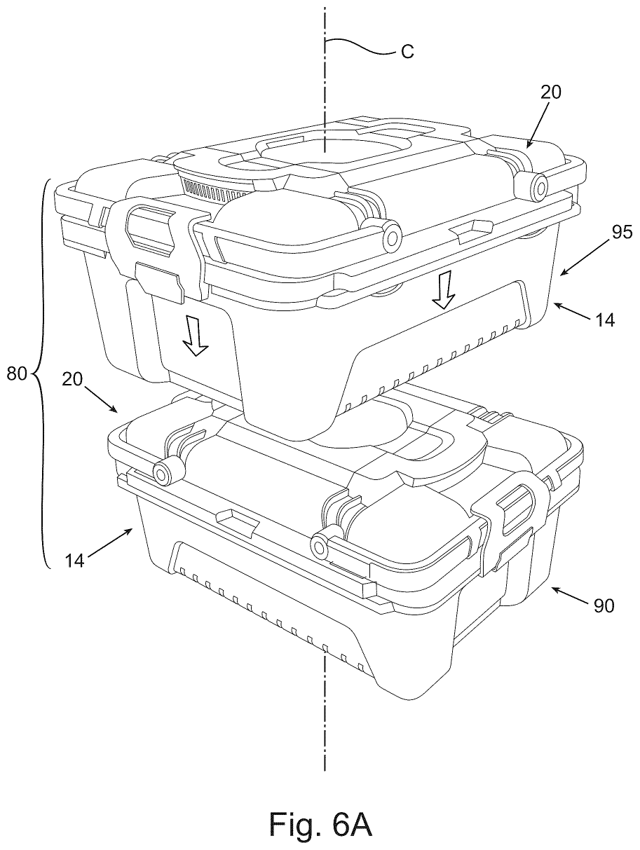

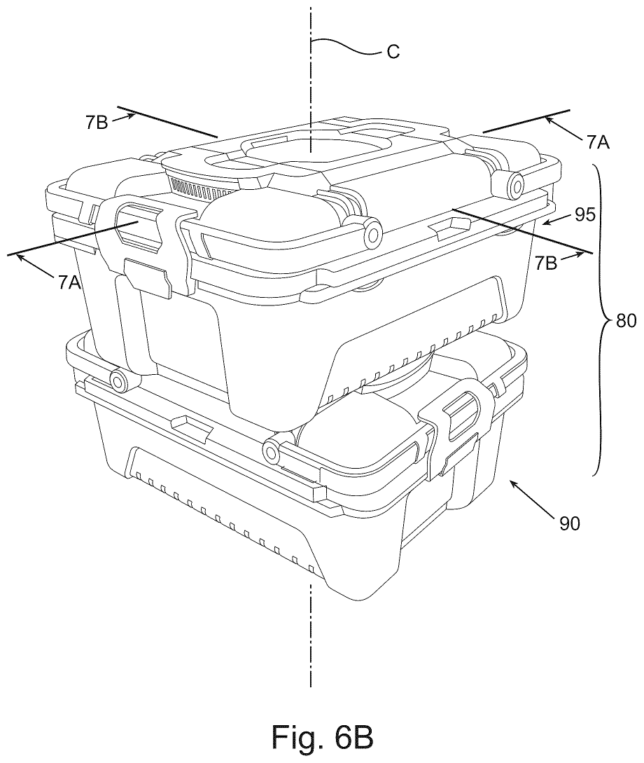

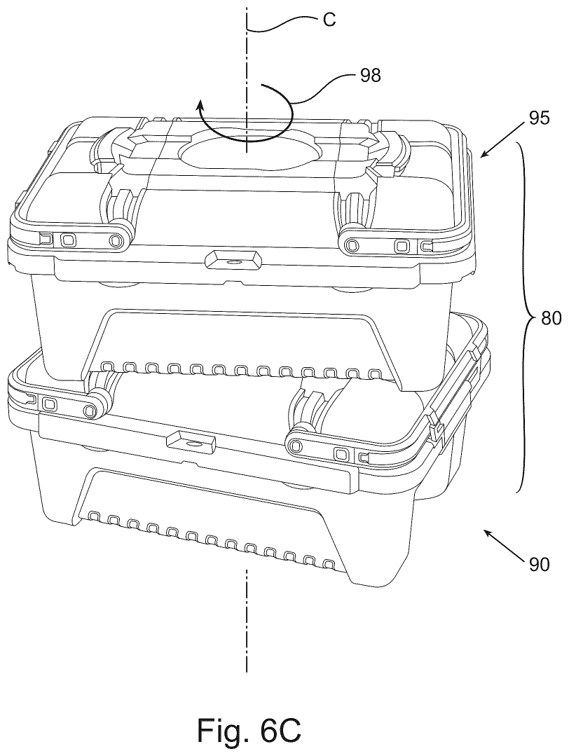

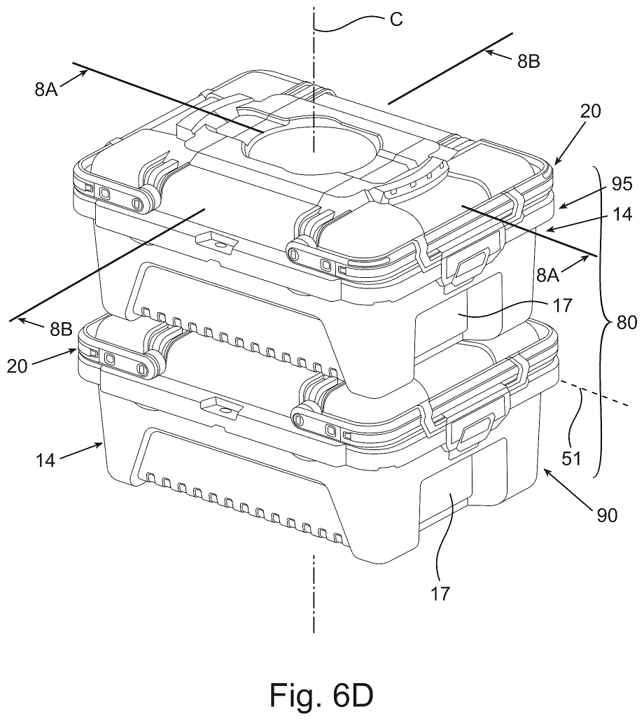

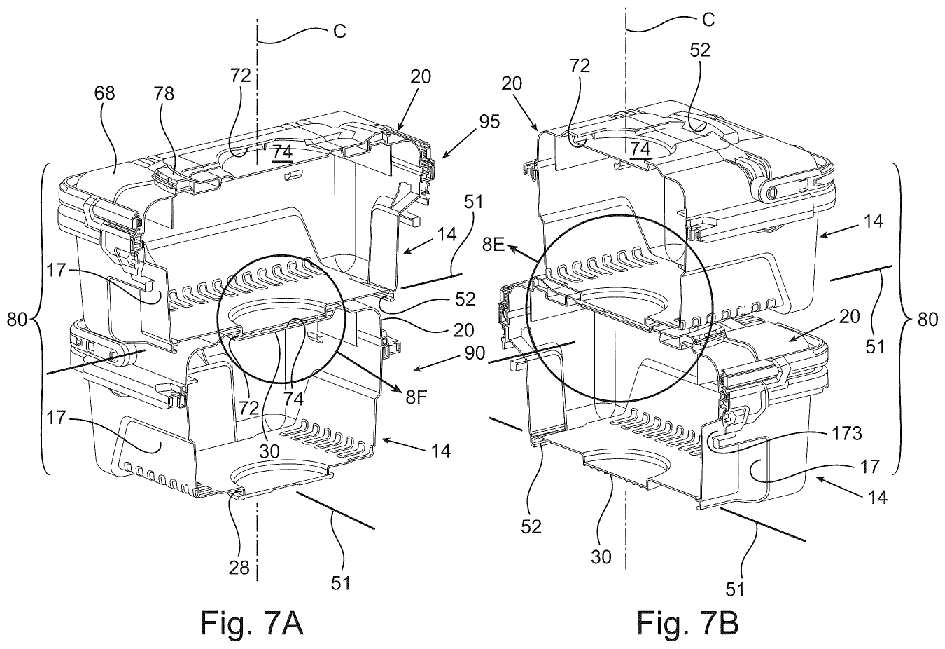

With further reference being made also to FIGS. 6 to 10, it is now discussed how utility modules can be detachably articulated to one another. For sake of clarity only, the terms ‘first utility module’ (interchangeably used with first container) and ‘second utility module’ (interchangeably used with second container) denote a base/bottom utility module/container and a top utility module/container, mountable thereover, respectively.

As can be seen in the sequence of assembly illustrated in FIGS. 6A to 6D, assembling a container assembly generally designated 80 takes place in the following order, using same reference numbers as mentioned hereinabove. First, a first container (utility module) 90 is obtained and placed, said container 90 configured with a lid similar with the disclosure of lid 20 described above. Then, a second container (utility module) 95 is obtained, said container 95 configured with a base similar with the disclosure of base 14 described above. The second container 95 is placed over the first container 90, however with the second container 95 disposed rotated at 90° about the central axis C (FIG. 6A). Then the projecting locking hub 30 of the second container 95 is disposed within the depressed receiving plane 74 with the second container 95 resting over first container 90 (FIG. 6B). At a further step (FIG. 6C) the second container 95 is rotated about the first container 90 at 90°, in direction of arrow 98. Rotation at an opposite direction is prevented by stopper members 40 and 75. Rotation of the second container 95 results in bayonet coupling of the male-female coupling pairs (FIG. 6D), namely central male locking members 28 of second utility module 95 engage within central female locking recesses 72 of the first utility module 90, and the male locking members 78 of the first utility module 90 engage within female locking recesses 52 of second utility module 95. At this final step, the second utility module 95 is engaged over the first utility module 90, the two utility modules now extending at the same orientation, namely aligned about axis 51.

In fact, the arrangement is such that first utility module is configured on a face thereof with a coupling mechanism comprising a male bayonet coupling portion and a female bayonet coupling portion coaxially disposed radially inwards of said male bayonet coupling portion, and the second utility module is configured on a face thereof with female bayonet coupling portion and a male bayonet coupling portion coaxially disposed radially inwards of said male bayonet coupling portion, and configured for interlocking articulation with the male bayonet coupling portion and a female bayonet coupling portion of the first utility module.

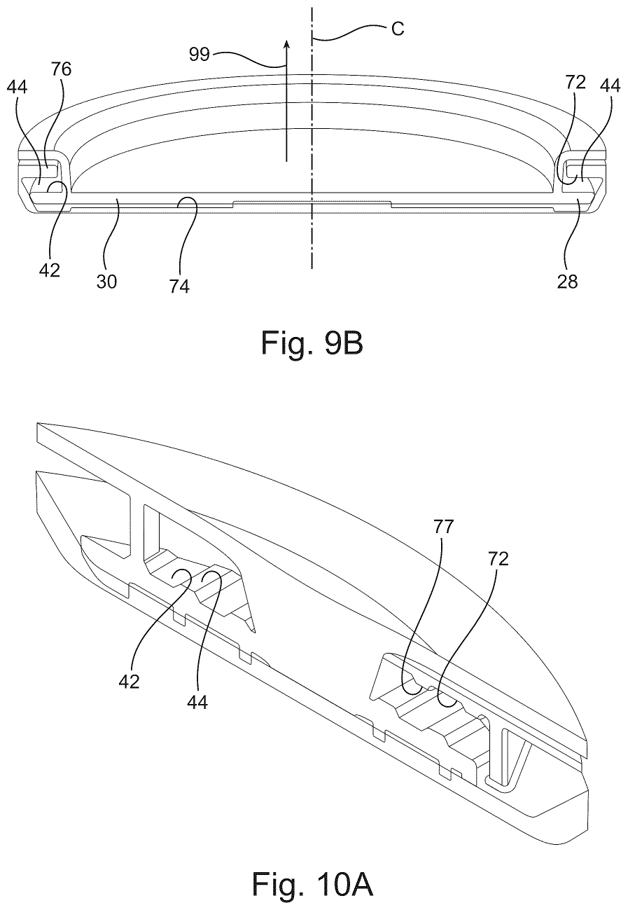

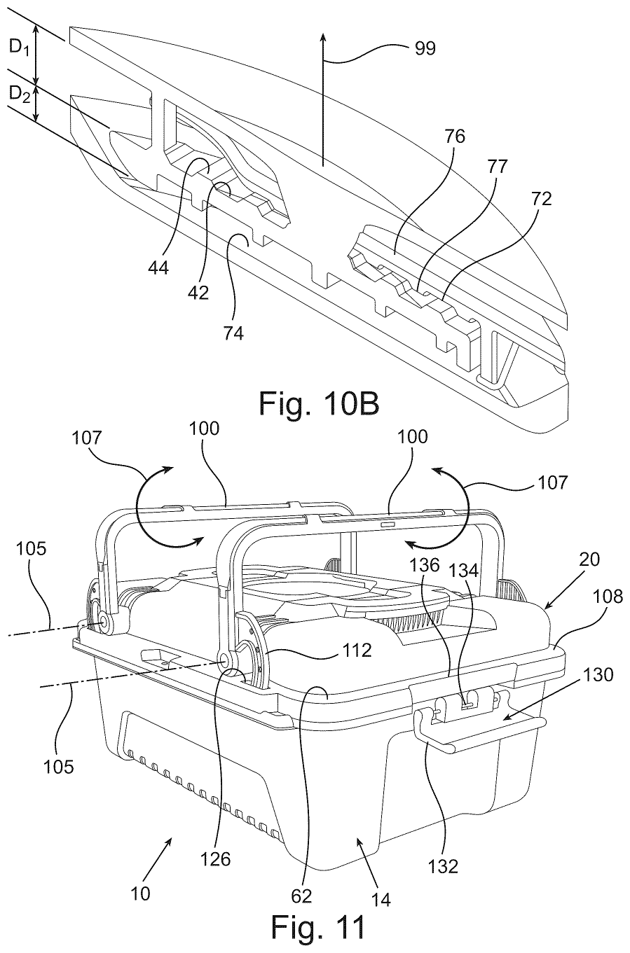

Once the two utility modules 90 and 95 are articulated, the utility module assembly 80 can be carried as a unit by lifting at either the first utility module 90 or second utility module 95. However, the assembly is configured with an arrangement to prevent unintentional rotation of the containers with respect to one another, possibly leading to unintentional detachment thereof. Further reference is made to FIGS. 9 and 10, illustrating only a central male-female coupling portion of the assembly 80. It is seen that when the two containers are articulated and engaged with one another as discussed hereinabove, and the second container 95 is at rest over the first container 90, there exists a small clearance between the locking members 28 and the locking recesses 72, namely ribs 44 of the male locking members 28 are spaced from, and disengaged from facing ribs 77 of locking recesses 72 (FIGS. 9A and 10A). However, lifting the assembly 80 by grabbing at the top (second) container 95 (in direction of arrow 99; FIGS. 9B and 10B), results in minor displacement along the central axis C, resulting in engagement of the ribs 44 with facing ribs 77, thus preventing rotation displacement therebetween.

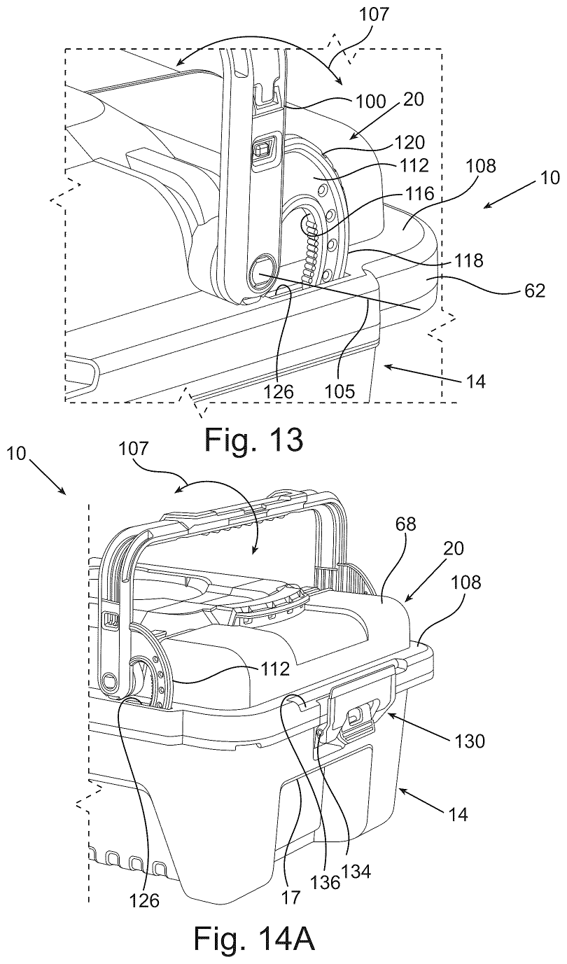

Furter attention is directed to FIGS. 11 to 15, concerned with a handle system and lid locking mechanism.

The container 10 illustrated in these figures is substantially similar to the container discussed hereinbefore, hence like reference numbers are used where relevant.

The lid 20 is configured with a pair of handles 100, each articulated near a side portion of the lid and being pivotable at a front/rear wall portion about a pivot axis 105 extending parallel with one another and parallel with back-front axis 32 of the container. The handles 100 are pivotally displaceable (in direction of arrow 107) between a locked position (e.g. FIGS. 1 to 3, 14C) extending substantially below the top face 68 of the 20, and above an annular shoulder 108 of the peripheral rim 62 of the lid 20, and an upright, unlocked position (FIGS. 11, 13 and 14A).

The handles 100 are each configured at their respective ends with an arc-shaped locking arm 112 having an inside face 116 and an outside face 118, both coaxially extending from pivot axis 105 about an imaginary radius. The inside face 116 is serrated and the outside face 118 is configured with notches 120. The arrangement is such that the annular shoulder 108 has an opening 126 such that the locking arm 112 is swingable within said opening 126 into a corresponding opening 128 at the top face of top edge 18 of the side walls 16 of the base 12. Said opening 128 is configured with an arresting block 131 (FIG. 15) having a serrated surface 133, said block having an arc-shape in correspondence with the arc of inside face 116 of locking arm 112, whereby said serrated surface 133 of arresting block 131 is configured for arresting engagement with serrated inside face 116 of the handle, whenever the latter is pivotally displaced into its locked position (e.g. FIGS. 1 to 3, 14C, 15) about a clicking path by said serrated surfaces.

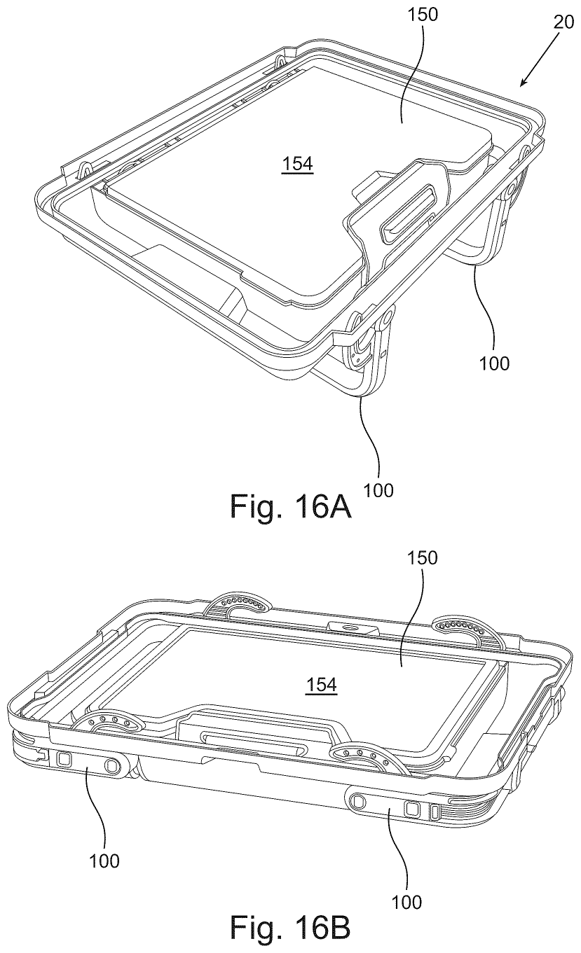

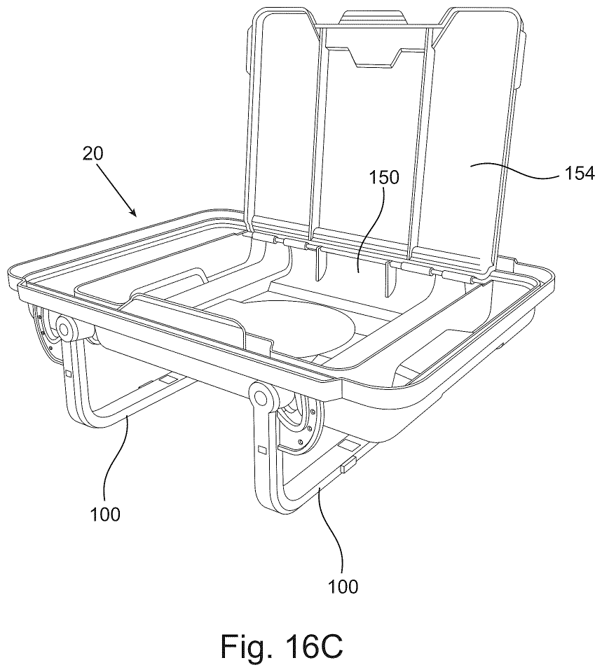

Once the handle 100 is pivotally displaced into its open position, the arm 112 disengages from the arresting block 131 and the lid is free to be removed from the container. At the open position the free end of locking arms 112 is disposed within the opening 126 of the lid, (FIGS. 16A and 16B).

Though swing handles 100 are referred to as handles, it is appreciated that the container 10 is configured at its opposite side walls 16 with a pair of container carrying/manipulating handles, in the form of depressions 17 configured below the locking mechanism 130 discussed hereinafter, said depressions 17 facilitating carrying the container also when heavily loaded.

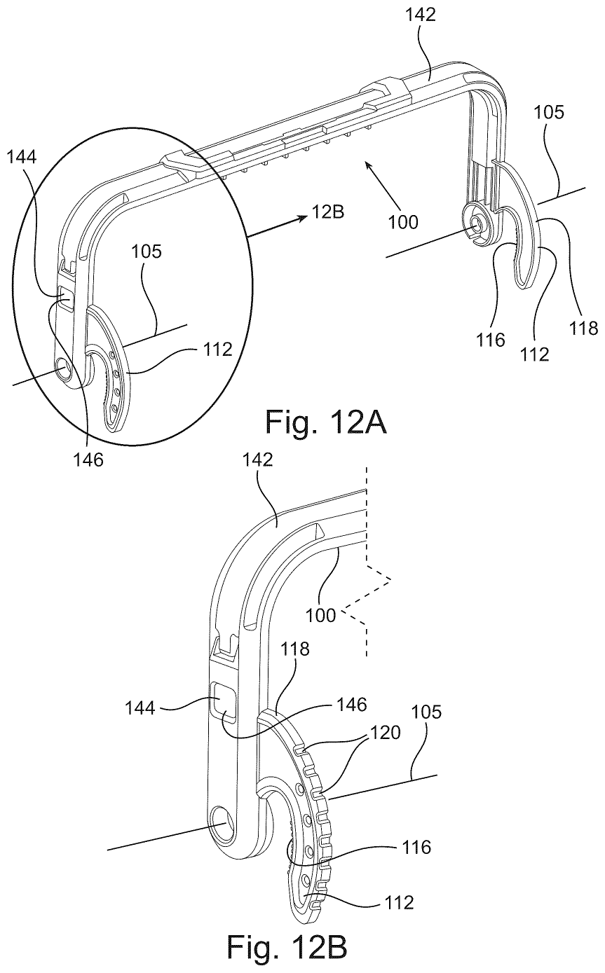

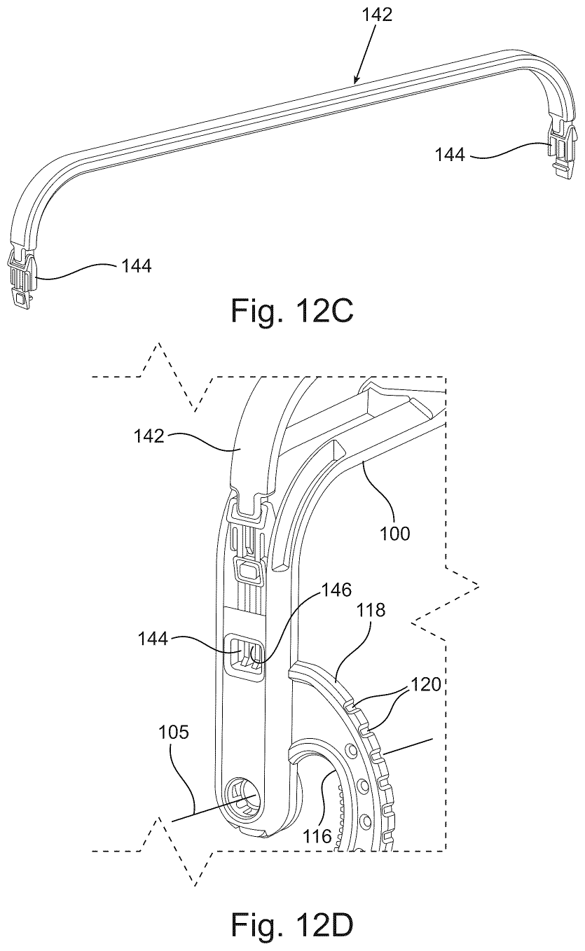

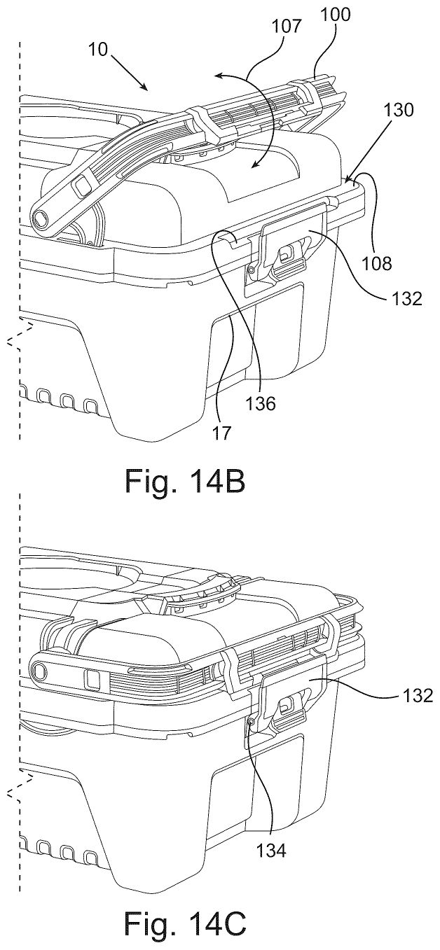

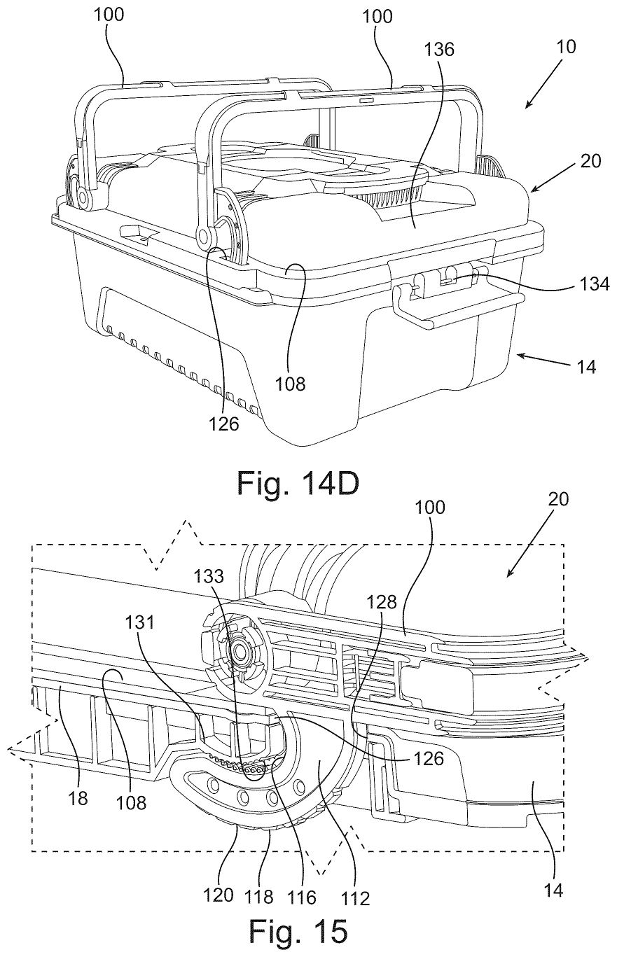

The container is configured also with a securing handle locking mechanism, generally designated 130, comprising a toggle type locking latch 132 pivotally secured about an axle 134 at a top portion of the respective side walls of the container. The arrangement is such that the latch 132 is pivotable between an unlocked position (best seen in FIGS. 11 and 14D) and a locked position, whereat the locked position the latch 132 snapingly engages over a locking ridge 136 of the lid 20, and further wherein at the locked position the latch 132 at least partially embraces a portion of the handle 100, thus securing the handle at the closed/locked position. However, it is appreciated that the latch 132 can be positioned at its locked position, however with the handle 100 at the upright, unlocked position. This is a position at which the handles 100 can serve for manipulating the lid of the container, or carrying the container (when no significant weight is received in the container) however with the lid 20 tightly secured over the body of the container. As seen in FIGS. 12A to 12D, the handle 100 is configured with a braided paracord 142 received within a groove at the handle 100 and detachably articulated by a pair of snap fasteners 144 designed for snap engagement with corresponding snap locks 146 at the handle 100. When articulated to the handle, the braided paracord 142 can serve as a cushioning member, and when detached it can be unbraided to assume its length for use as may be required. Instead of the paracord, a resilient padded member can be applied (not shown) to the handle.

In FIG. 16A the lid 20 is illustrated at a table/elevated tray position, wherein the two handles 100 are pivoted into the fully open position whereby the lid can rest elevated over a surface and a bottom surface of the lid can serve as a work surface. In the example of FIGS. 16A to 16C, the lid 20 is configured at a bottom face thereof with an organizer 150 detachable articulated to the lid. An outside face of cover 154 of the organizer serves as a work surface, and the handles are prevented from spontaneous collapsing into the closed position by an arresting ridge (not shown) configured for clicking engagement with notches 120 of arm 112 of the handle. Alternatively, the handles can be pivoted beyond 90° to reduce likelihood of spontaneous collapsing.

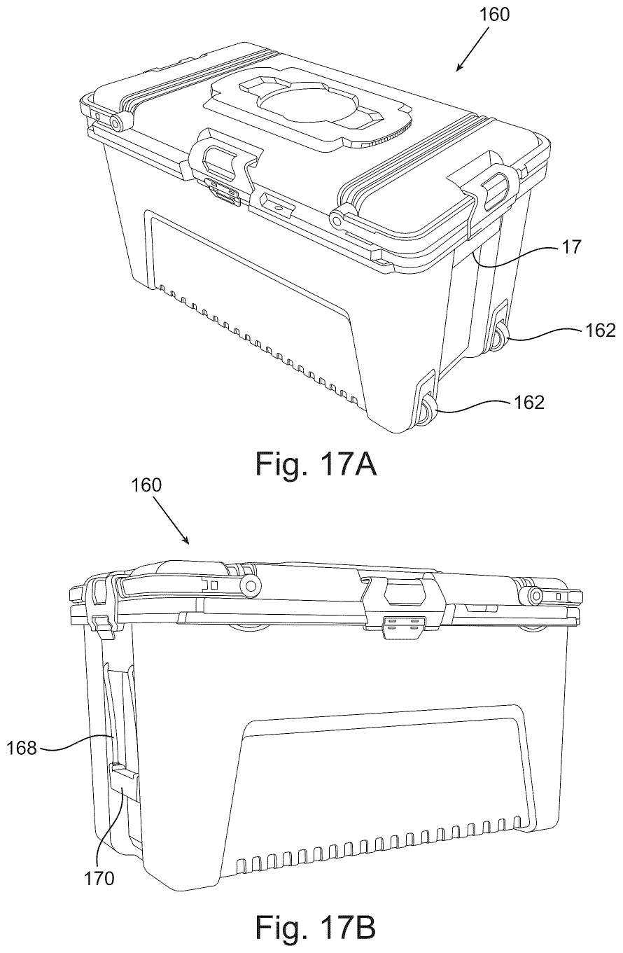

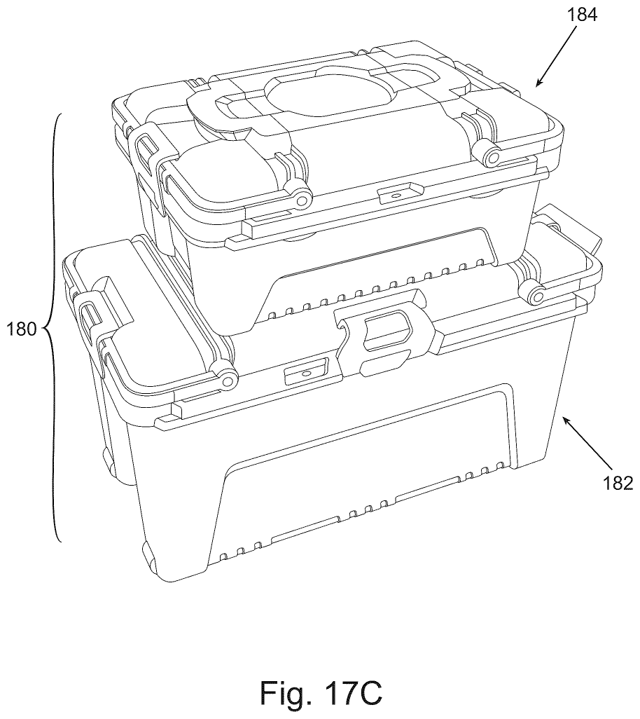

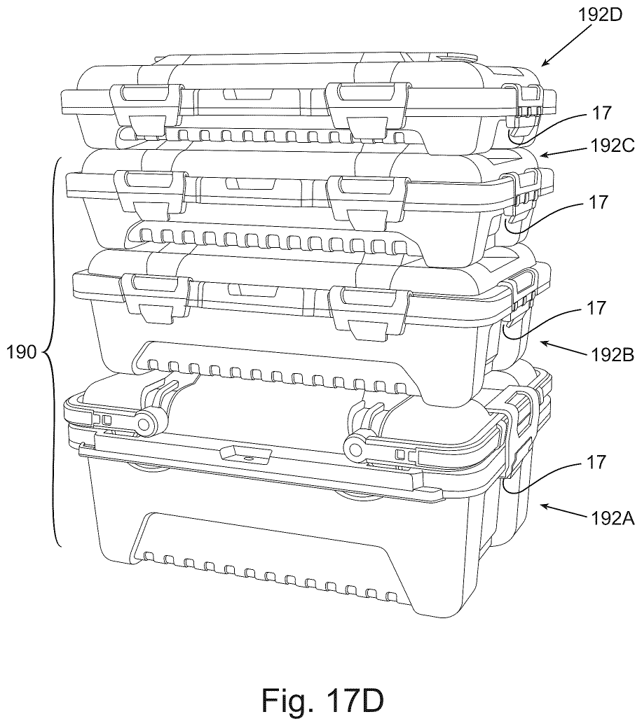

FIG. 17A illustrates a utility module, namely a container 160 according to an example of the disclosure, said container configured with a coupling mechanism and other features as discussed hereinabove, and further comprising a pair of wheels 162 at a bottom portion, whereby the container can be wheeled thereover. The container 160 shown in FIG. 17B features a flexible handle 168, comprising a flexible steel core encapsulated within a resilient coating and fitted with a grip 170 for carrying the container.

A container according to the illustrated example is further configured with secure-down (tie-down) arrangement, namely an opening 173 configured (FIGS. 1B, 2A, 7B, 8A) for securing the container e.g., to a truck bed or any carrying platform (not shown), using a bungee cord, ratchet cable, etc.

FIG. 17C illustrates a container assembly 180 comprising a first container 182 and a second container 184 articulated thereover, however where the second container has a footprint smaller than that of the first container. In the illustrates example the male coupling portion (not seen) at the lid of the first container 182 is disposed closer to the center of the container, in order to engage with a corresponding female coupling portion of the second container 184. Alternatively, a second utility module can be articulated over the first utility module only by the central male/female coupling mechanism (not shown).

FIG. 17D illustrates a four-tier utility module assembly, generally designated 190 and comprising four containers 192A-192D, articulated on top of one another by the male-female bayonet coupling mechanism discussed hereinbefore, whereby the base container 192A serves as first container with respect to second container 192B articulated thereto, and however wherein container 192B serves as a first container with respect to a second container 192C, and so on.

1. A utility assembly comprising:
at least one first utility module and at least one second utility module; and
a coupling mechanism for detachable articulation a second utility module to a first utility module, said coupling mechanism comprising a male coupling portion associated with one of the at least one first utility module and the at least one second utility module, and a female coupling portion associated with another one of the at least one first utility module and the at least one second utility module;
wherein:
the male coupling portion is configured with at least a pair of symmetrically distributed locking members laterally projecting from a male rotation axis normal to a projecting locking plane, and
the female coupling portion is configured with at least a pair of corresponding symmetrically distributed locking recesses extending from a female rotation axis normal to a depressed receiving plane, said locking members being disposed in register with said locking recesses and said female rotation axis coinciding with said male rotation axis, and
said locking members are configured for rotation engagement by said locking recesses.

2. (canceled)

3. The utility assembly of claim 1, wherein each one of the first utility module and the second utility module comprises a male coupling portion and a female coupling portion, wherein the male rotation axis and the female rotation axis of each of the first utility module and the second utility module coincide, and wherein the male coupling portion and the female coupling portion are coaxially disposed at different radii.

4. The utility assembly of claim 1, wherein the locking members are disposed at 90° with respect to the locking recesses of a respective utility module.

5. The utility assembly of claim 1, wherein at an assembled, interlocked position, the second utility module is disposed over the first utility module such that side walls of both utility modules face at same orientation.

6. The utility assembly of claim 1, wherein a second utility module comprising only one of the male coupling portion and the female coupling portion, are articulated over the first utility module using one of the other one of the male coupling portion and the female coupling portion, and a second utility module comprising both of the male coupling portion and the female coupling portion can be articulated over the first utility module using both of the male coupling portion and the female coupling portion.

7. The utility assembly of claim 1, wherein the laterally projecting locking members of the male coupling portion and the locking recesses of the female coupling portion are disposed parallel with regular edges of the first utility module and the second utility module, respectively.

8. The utility assembly of claim 1, wherein locking engagement takes place in two ene-directions, and according to another arrangement locking engagement takes place in one direction only, wherein one or both of at least one of the locking members and of the at least one of the locking recesses is configured with a stopper, whereby engaging is unidirectional, such that the second utility module can be rotated into engagement with the first utility module in one direction only.

9. (canceled)

10. The utility assembly of claim 1, wherein a footprint of the second utility module can be smaller or greater than a footprint of the first utility module, whereby only a center, inner most couple of a male-female coupling is configured for rotation engagement with one another.

11. The utility assembly of claim 1, wherein one or both of the first utility module and the second utility module is a container.

12. The utility assembly of claim 11, wherein the container is configured for water-tight sealing, by a sealing gasket deposed at least at a lid of the container.

13. (canceled)

14. The utility assembly of claim 1, wherein at the first utility module, a topmost surface of the male coupling portion is coplanar with a topmost portion of the female coupling portion, and wherein at the second utility module a bottommost surface of the male coupling portion is coplanar with a bottommost portion of the female coupling portion.

15.-17. (canceled)

18. The utility assembly of claim 1, wherein a surface of the locking members of the male coupling portion and a corresponding facing surface of the locking recesses of the female coupling portion is configured with a rotation preventing mechanism.

19. The utility assembly of claim 18, wherein the rotation preventing mechanism comprises mating ridges and depressions disposed over facing surfaces of the locking recesses of the female coupling portion, said rotation preventing mechanism configured for engagement when the first utility module and the second utility module are interlocked and upon applying axial displacement of the second utility module with respect the first utility module; such axial displacement occurs upon lifting an assembled utility assembly by the second utility module, the rotation preventing mechanism is configured to eliminate or substantially reduce the likelihood of unintentional rotational disengagement of the second utility module from the first utility module.

20. (canceled)

21. The utility assembly of claim 11, wherein a top surface of the first container is configured with depressed gliding surfaces, having chamfered edges, for positioning the male coupling portion of the second utility module in a prior-to-locking position with respect to the female coupling portion of the first utility module.

22. (canceled)

23. The utility assembly of claim 11, wherein the container is configured with a double locking mechanism for securely locking a lid over the container at a closed position, wherein a first locking mechanism of the container comprises at least a pair of side latches, each disposed at opposite sides of the container and where each latch is pivotally articulated at one of the lid and side wall of the container and configured for lock-engagement with a lock arrest configured at the other one of the lid and side wall of the container.

24. (canceled)

25. (canceled)

26. The utility assembly of claim 23, wherein a second locking mechanism of the container comprises one or more of swing handles, each comprising a handle portion pivotally articulated at a side wall portion of the lid and comprising at respective ends thereof an arced arm projectable through a top surface of the lid and configurable between a locked position at which the handle is displaced against the lid and wherein each arced arm engages with an arresting aperture at a top portion of a side wall of the container, and an unlocked position wherein the handle is displaced from the top surface of the lid and wherein the arced arms disengage from the respective arresting aperture.

27. (canceled)

28. (canceled)

29. The utility assembly of claim 26, wherein the arced arm is eccentric and configured for increasing arresting engagement with the arresting aperture as it is pivotally displaced into its closed position, thus increasing sealing force of the lid over the container.

30. (canceled)

31. The utility assembly of claim 11, wherein a lid of the container is configured at an inside face thereof with an organizer.

32. (canceled)

33. The utility assembly of claim 11, wherein the container is configured with a braided paracord, detachably articulated to a portion of the container.

34. (canceled)

35. (canceled)

36. The utility assembly of claim 11, wherein the container is configured with two or more secure-down (tie down) arrangements, disposed at opposite sides of the container, for securing the container to a carrying platform.

37.-40. (canceled)
